(19) United States
(12) Patent Application Publication
(10) Pub. No.: US 2019/0026053 A1
(43) Pub. Date: Jan. 24, 2019

(54) PRINT INSTRUCTION CONTROL APPARATUS, PRINT CONTROL APPARATUS, PRINT CONTROL SYSTEM, AND NON-TRANSITORY COMPUTER READABLE MEDIUM

(71) Applicant: FUJI XEROX CO., LTD., Tokyo (JP)

(72) Inventor: Kei ARAKAWA, Kanagawa (JP)

(73) Assignee: FUJI XEROX CO., LTD., Tokyo (JP)

(21) Appl. No.: 16/027,453

(22) Filed: Jul. 5, 2018

(30) Foreign Application Priority Data
Jul. 19, 2017 (JP) 2017-140335

(51) Int. Cl. G06F 3/12

(52) U.S. Cl. CPC G06F 3/1255; G06F 3/1259; G06F 3/1207

(57) ABSTRACT

A print instruction control apparatus includes a transmitter, a receiver, and a display. The transmitter transmits, to a print control apparatus that controls printing, designation information for designating a function used in printing. In response to transmission of retention information retained by the print control apparatus regarding the function on receipt of the designation information transmitted by the transmitter, the receiver receives the retention information. The display displays the retention information received by the receiver.

### CROSS-REFERENCE TO RELATED APPLICATIONS

This application is based on and claims priority under 35 USC 119 from Japanese Patent Application No. 2017-140335 filed Jul. 19, 2017.

### BACKGROUND

### (i) Technical Field

The present invention relates to a print instruction control apparatus, a print control apparatus, a print control system, and a non-transitory computer readable medium.

### (ii) Related Art

When a configuration is adopted where a print control apparatus that controls printing retains information regarding a manufacturer-by-manufacturer function used in printing and checks that information, another apparatus such as a print instruction control apparatus that manages multiple print control apparatuses is unable to check information retained regarding a function by each print control apparatus.

### SUMMARY

According to an aspect of the invention, there is provided a print instruction control apparatus including a transmitter, a receiver, and a display. The transmitter transmits, to a print control apparatus that controls printing, designation information for designating a function used in printing. In response to transmission of retention information retained by the print control apparatus regarding the function on receipt of the designation information transmitted by the transmitter, the receiver receives the retention information. The display displays the retention information received by the receiver.

### BRIEF DESCRIPTION OF THE DRAWINGS

An exemplary embodiment of the present invention will be described in detail based on the following figures, wherein:

FIG. 1 is a diagram illustrating an exemplary overall configuration of a workflow system to which an exemplary embodiment of the present invention is applied;

FIG. 2 is a diagram illustrating an exemplary hardware configuration of a workflow server according to the exemplary embodiment of the present invention;

FIG. 3 is a diagram illustrating an exemplary hardware configuration of a print system according to the exemplary embodiment of the present invention;

FIG. 4 is a diagram illustrating an exemplary digital front end (DFE) list screen displayed by the workflow server according to the exemplary embodiment of the present invention;

FIG. 5 is a diagram illustrating an exemplary option setting screen displayed by the workflow server according to the exemplary embodiment of the present invention;

FIG. 6 is a diagram illustrating a state in which the workflow server according to the exemplary embodiment of the present invention displays a user interface (UI) image on the option setting screen;

FIG. 7 is a diagram illustrating a state in which the workflow server according to the exemplary embodiment of the present invention displays text information on the option setting screen;

FIG. 8A is a diagram illustrating a state in which an option is set on the option setting screen;

FIG. 8B is a diagram illustrating the state of the option setting screen in the case where, in the state illustrated in FIG. 8A, an operator changes a DFE serving as a transmission destination of print instruction information;

FIG. 9 is a block diagram illustrating an exemplary functional configuration of the workflow server and DFE according to the exemplary embodiment of the present invention; and

FIG. 10 is a sequence diagram illustrating an exemplary operation of the workflow server and DFE according to the exemplary embodiment of the present invention.

### DETAILED DESCRIPTION

Hereinafter, an exemplary embodiment of the present invention will be described in detail with reference to the accompanying drawings.

### Background of Exemplary Embodiment

The printing industry in recent years has demanded higher efficiency in the entire printing process because importance has been placed on cost reduction. Therefore, a printing process of printing image data based on print data on a recording medium such as paper is processed by multiple print systems (their manufacturers are not always identical). Accordingly, multiple digital front ends (DFEs; print control apparatuses) are managed. Because of these circumstances, attention has been paid to a workflow system capable of handling multiple DFEs of different manufacturers, which process a printing process in the whole process related to printing work. In such a workflow system, a workflow server is connected to multiple DFEs that may be manufactured by different manufacturers (hereinafter, a DFE manufactured by company X will be referred to as a “company-X DFE”). The workflow server performs processing from settings of options on information instructing printing (hereinafter referred to as “print instruction information”) to transmission of the print instruction information to any of the DFEs.

However, the specification (operation) of detailed settings (options) of a printing process in a printer, which is set by the workflow server, may be different from the specification (operation) of options set by each-company DFE. In such a case, when the operator does not recognize that the specification is different, the operator may set wrong options to perform printing, which may result in a problem.

Therefore, in the exemplary embodiment, the operator is enabled to set the correct options of each-company DFE.

### Overall Configuration of Workflow System

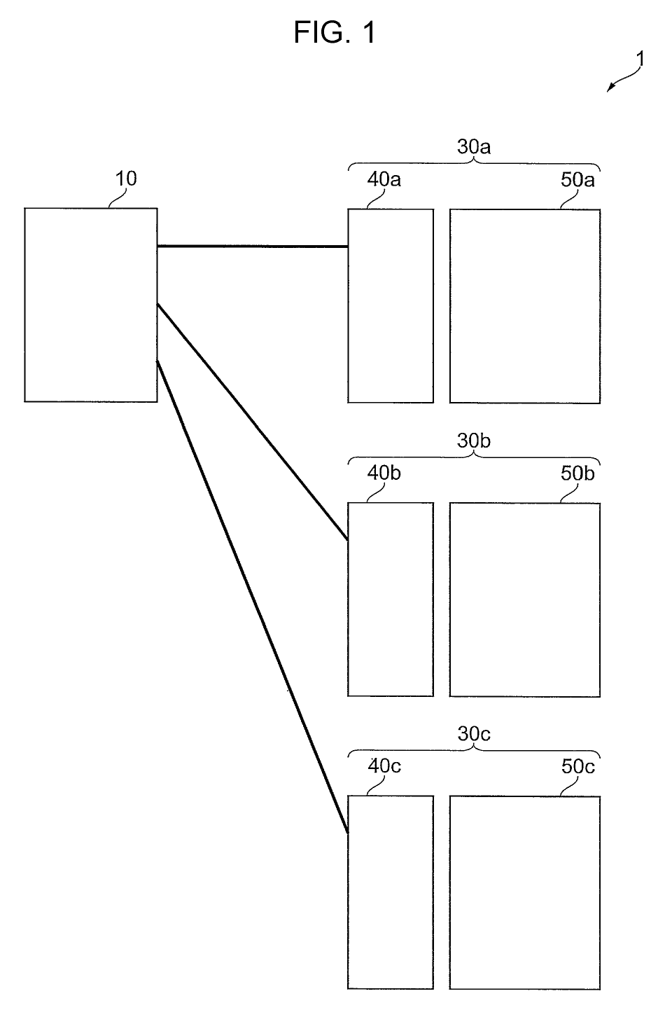

FIG. 1 is a diagram illustrating an exemplary configuration of a workflow system 1 to which the exemplary embodiment is applied. As illustrated in FIG. 1, the workflow system 1 includes a workflow server 10 and print systems 30a, 30b, and 30c, which are connected by communication lines. Here, the print systems 30a, 30b, and 30c will be collectively referred to as the print systems 30 when it is unnecessary to distinguish them. Although three print systems 30 are illustrated, the number of print systems 30 is not restricted to three. In addition, the print system 30a is configurated by connecting a DFE 40a and a printer 50a; the print system 30b is configurated by connecting a DFE 40b and a printer 50b; and the print system 30c is configurated by connecting a DFE 40c and a printer 50c. Here, it is assumed that the DFEs 40a, 40b, and 40c are company-A DFE, company-B DFE, and company-C DFE, respectively; however, they may be collectively referred to as the DFEs 40 when it is unnecessary to distinguish them. In addition, the printers 50a, 50b, and 50c will be collectively referred to as the printers 50 when it is unnecessary to distinguish them. Although one printer 50 for one DFE 40 is illustrated, there may be two or more printers 50 for one DFE 40. In other words, a DFE 40 manufactured by a certain manufacturer may control different printers 50 manufactured by the same manufacturer. In the workflow system 1, a portion including the workflow server 10 and the DFEs 40a, 40b, and 40c is an example of a print control system.

The workflow server 10 is a server computer that gives a print instruction to each DFE 40. The workflow server 10 sets options for print instruction information for instructing any of the printers 50 to perform printing, and transmits the print instruction information to a DFE 40 that controls that printer 50. Although a server that manages each DFE 40 for the whole printing process is referred to as the workflow server 10 here, the exemplary embodiment pays attention to, in the whole printing process, a process of printing on a recording medium such as paper. In the exemplary embodiment, the workflow server 10 is provided as an example of a print instruction control apparatus or a print instruction controller that controls a print instruction.

Each print system 30 is an apparatus that performs printing using a corresponding one of the printers 50 under control of a corresponding one of the DFEs 40.

Each DFE 40 is an apparatus that controls printing performed by a corresponding one of the printers 50. Here, it is assumed that each DFE 40 supports Job Definition Language (JDF). JDF is a standard format for describing instruction information for the whole printing process defined by the International Cooperation for the Integration of Processes in Prepress, Press, and Postpress Organization (CIP4), which is a printing industry association. In addition, each DFE 40 communicates with the workflow server 10 using Job Messaging Format (JMF), which is part of the JDF schema. In the exemplary embodiment, each DFE 40 is provided as an example of a print control apparatus or a print controller that controls printing.

Each printer 50 is a mechanism that performs printing (forming an image on a recording medium such as paper). In addition to the above function, each printer 50 may have functions such as reading an image from a recording medium such as paper, transmitting an image to a public line, and receiving an image from a public line. Each printer 50 may use a cut sheet or continuous form paper as a recording medium such as paper.

### Hardware Configuration of Workflow Server

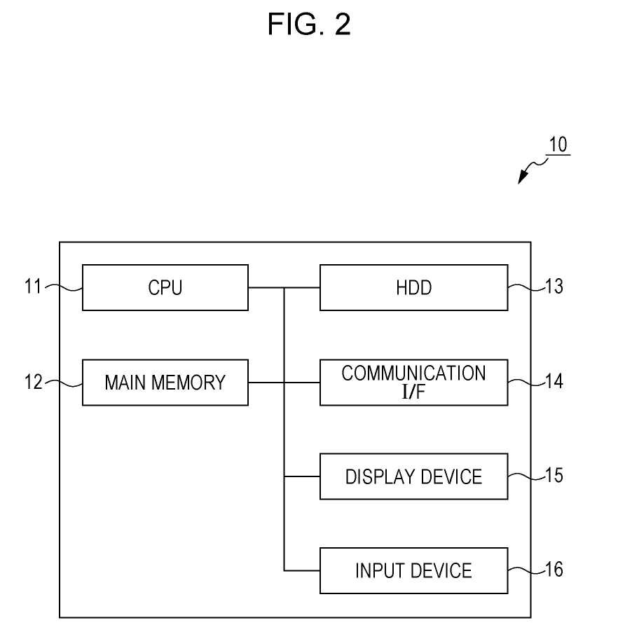

FIG. 2 is a diagram illustrating an exemplary hardware configuration of the workflow server 10 according to the exemplary embodiment. As illustrated in FIG. 2, the workflow server 10 includes a central processing unit (CPU) 11, which is a computing unit, and main memory 12 and a hard disk drive (HDD) 13, which are storage units. Here, the CPU 11 realizes functions described later by executing various types of software such as the operating system (OS) and applications. The main memory 12 is a storage area for storing various types of software and data used in executing the software. The HDD 13 is a storage area for storing input data for and output data from various types of software. Furthermore, the workflow server 10 includes a communication interface (I/F) 14, which is for communicating with the outside, a display device 15, such as a display, and an input device 16, such as a keyboard and a mouse.

### Hardware Configuration of Print System

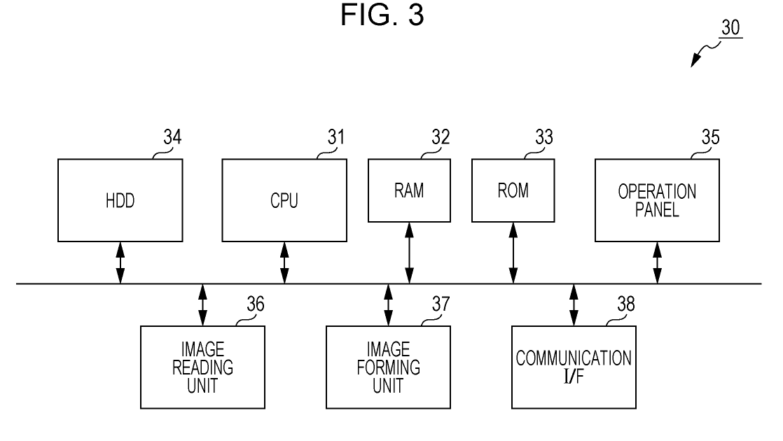

FIG. 3 is a diagram illustrating an exemplary hardware configuration of each print system 30 according to the exemplary embodiment. As illustrated in FIG. 3, each print system 30 includes a CPU 31, random-access memory (RAM) 32, read-only memory (ROM) 33, an HDD 34, an operation panel 35, an image reading unit 36, an image forming unit 37, and a communication I/F 38. Among these units, the CPU 31, the RAM 32, the ROM 33, the HDD 34, the operation panel 35, and the communication I/F 38 are elements of each DFE 40. Here, it is assumed that each printer 50 reads an image from a recording medium such as paper, in addition to forming an image on a recording medium such as paper, and it is assumed that the image reading unit 36 and the image forming unit 37 are elements of each printer 50.

The CPU 31 realizes functions described later by loading various programs stored in the ROM 33 or the like to the RAM 32 and executing the programs.

The RAM 32 is memory used as, for example, work memory for the CPU 31.

The ROM 33 is memory for storing, for example, various programs executed by the CPU 31.

The HDD 34 is a magnetic disk drive, for example, which stores image data read by the image reading unit 36 or image data used in forming an image by the image forming unit 37.

The operation panel 35 is a touchscreen, for example, which displays various types of information and accepts operation entries input by a user. Here, the operation panel 35 includes a display on which various types of information are displayed, and a position detecting sheet for detecting a position designated with a finger or a stylus pen, for example. Alternatively, a display and a keyboard may be used, instead of a touchscreen.

The image reading unit 36 reads an image recorded on a recording medium such as paper. Here, the image reading unit 36 is a scanner, for example, which uses a charge coupled device (CCD) system where reflected light of light emitted from a light source to a document is reduced in size by a lens and received by CCDs, or a contact image sensor (CIS) system where reflected light of light beams emitted in order from a light-emitting diode (LED) light source to a document is received.

The image forming unit 37 forms an image on a recording medium. Here, the image forming unit 37 is a printer, for example, which uses an electrophotographic system that transfers toners attached to a photoconductor to a recording medium to form an image, or an inkjet system that discharges ink onto a recording medium to form an image.

The communication I/F 38 performs transmission/reception of various types of information with another apparatus via a communication line.

### Overview of Exemplary Embodiment

At first, a schematic operation in the case of checking the specification (operation) of options in each DFE 40 from the workflow server 10 will be described.

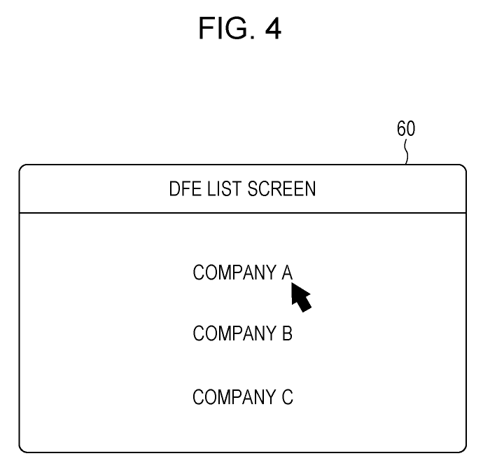

FIG. 4 is a diagram illustrating an exemplary DFE list screen 60 displayed by the workflow server 10. As illustrated in FIG. 4, the DFE list screen 60 displays, as an option, a company name corresponding to each DFE 40. Note that this is only one example, and the model name of each DFE 40 may be displayed as an option. If, for example, “company A” is selected on the DFE list screen 60, the workflow server 10 displays a company-A DFE option setting screen.

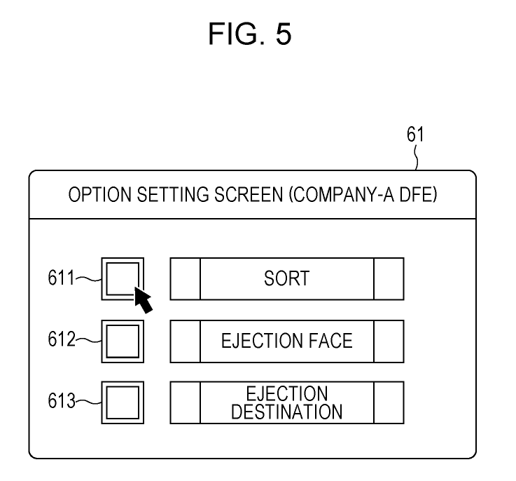

FIG. 5 is a diagram illustrating an example of a company-A DFE option setting screen 61 displayed by the workflow server 10. As illustrated in FIG. 5, the company-A DFE option setting screen 61 displays, as an option, the option name of an option settable in the DFE 40a in print instruction information. That is, the option name of an option that is not settable in the DFE 40a in print instruction information is not displayed as an option. Note that this is only one example. The option name of an option that is not settable in the DFE 40a in print instruction information may be displayed without distinguishing it from the option name of an option settable in the DFE 40a in print instruction information, or may be displayed in a format (such as in a grayed-out appearance) different from the option name of an option settable in the DFE 40a in print instruction information.

On the option setting screen 61, the option “sort” is an option for sorting a printed recording medium and outputting the sorted recording medium. This option is set by, for example, left-clicking the mouse on a checkbox 611 to check the checkbox 611. In addition, the option “ejection face” is an option indicating which side of a printed recording medium faces up in the case of sorting a printed recording medium and outputting the sorted recording medium. This option is set by, for example, left-clicking the mouse on a checkbox 612 to display candidates for the ejection face (front side or back side) and selecting one of the candidates. In addition, the option “ejection destination” is an option indicating to which ejection destination a printed recording medium is output in the case of sorting a printed recording medium and outputting the sorted recording medium. This option is set by, for example, left-clicking the mouse on a checkbox 613 to display candidates for the ejection destination (automatic selection, ejection destination 1, ejection destination 2, and so forth) and selecting one of the candidates. In the exemplary embodiment, the option setting screen 61 is used an example of a screen of a print instruction control apparatus for setting a function, and left-clicking of the mouse is used as an example of an operation of setting a function.

In FIG. 5, an option group including the option “sort” and the options “ejection face” and “ejection destination” associated with the option “sort” is displayed on the option setting screen 61. However, other options that do not belong to this option group, such as “rotate by 180 degrees” and “invert horizontally”, may further be displayed.

In response to right clicking the mouse on, for example, the checkbox 611 on the option setting screen 61, the workflow server 10 transmits this operation to the DFE 40a. The DFE 40a transmits, to the workflow server 10, option information corresponding to the option “sort” in the workflow server 10, and the workflow server 10 displays the option information received from the DFE 40a. In the exemplary embodiment, the option setting screen 61 is used an example of a screen of a print instruction control apparatus for designating a function, and right-clicking of the mouse is used as an example of an operation of designating a function. Although an operation of designating an option and an operation of setting an option are both performed on the same option setting screen 61 in the above example, these operations may be performed on different screens.

Here, the option information refers to information retained by the DFE 40a regarding an option in the workflow server 10. In other words, the option information is information that is retained independently by multiple DFEs 40 including the DFE 40a regarding an option in the workflow server 10. As has been described above, in the case where multiple DFEs 40 independently retain the same information regarding an option in the workflow server 10, these DFEs 40 are often of an identical manufacturer or of an identical model. Thus, it may be said that the option information is information that is retained independently by multiple DFEs 40 of an identical manufacturer or of an identical model regarding an option in the workflow server 10. It may also be said that the option information is information different from information that is retained independently by one or more DFEs 40 other than the DFE 40a regarding an option in the workflow server 10. As has been described above, when another DFE 40 retains different information regarding an option in the workflow server 10, this other DFE 40 is often a DFE 40 of a different manufacturer or of a different model. Thus, it may be said that the option information is information different from information retained by another DFE 40 of a different manufacturer or of a different model regarding an option in the workflow server 10. Here, the model is the type of a product, and includes, for example, the series of a product and the model number of a product. In the exemplary embodiment, an option is used as an example of a function used in printing, and option information is used as an example of retention information retained by a print control apparatus regarding a function. Here, a function used in printing refers to an action of applying some processing to an image or a recording medium when performing printing, and includes, for example, processing such as rotation of an image and sorting of a recording medium.

For example, the option information may be information indicating whether each DFE 40 has that option or not, that is, information indicating whether that option is settable or not in each DFE 40. In the case of displaying only an option settable in each DFE 40 on the option setting screen 61, this information is unnecessary. However, this information is useful in the case of displaying on the option setting screen 61 an option that is settable and also an option that is not settable in each DFE 40 without distinguishing between these options.

In addition, the option information may be operation information regarding that option in each DFE 40. Here, the operation information refers to information indicating the operation of that option in each DFE 40. The operation information may be image information or text information. An example of image information includes an image of a UI screen (hereinafter referred to as a “UI image”) for setting that option in each DFE 40. Examples of text information include information on a path to a UI screen for setting that option in each DFE 40, and information describing the operation of that option in each DFE 40. In the exemplary embodiment, the operation information is used as an example of specification information indicating the specification of a function in a print control apparatus.

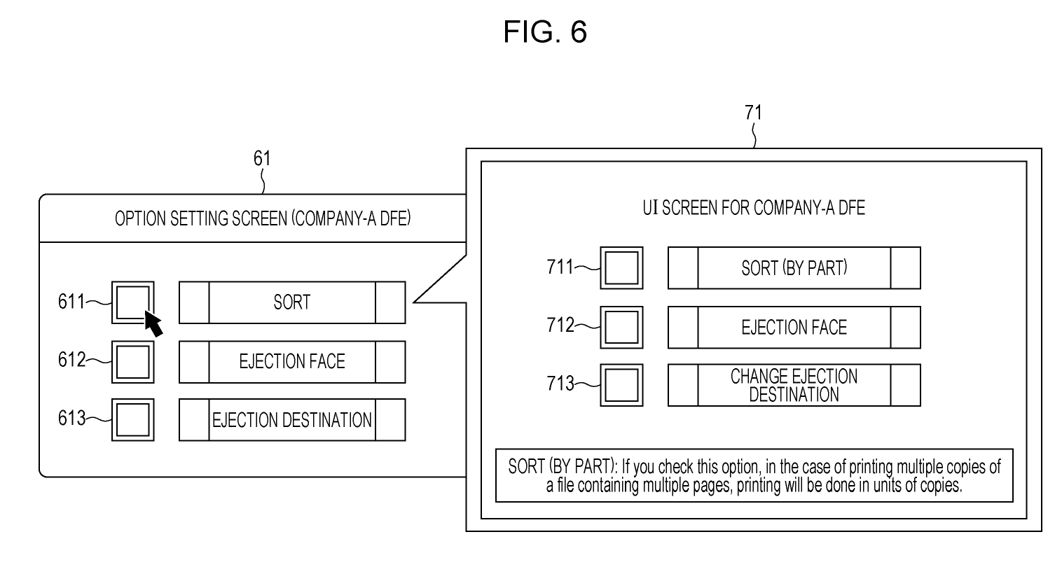

FIG. 6 is a diagram illustrating a state in which the workflow server 10 displays a UI image 71 on the option setting screen 61. Here, the UI image 71 is an image of a UI screen for setting the option “sort” in the DFE 40a. The UI image 71 may be, for example, a Joint Photographic Experts Group (JPEG) image.

As illustrated in FIG. 6, a UI screen for setting the option “sort” in the DFE 40a displays, as an option, the option “sort (by part)” corresponding to the option “sort”. This option is set by, for example, left-clicking the mouse on a checkbox 711 to check the checkbox 711. As has been described above, because the options “sort”, “ejection face”, and “ejection destination” belong to the same option group, the UI screen for setting the option “sort” in the DFE 40a also displays, as options, the options “ejection face” and “change ejection destination” corresponding to the options “ejection face” and “ejection destination”, respectively. Among these options, the option “ejection face” is set by, for example, left-clicking the mouse on a checkbox 712 to display candidates for the ejection face (front side or back side) and selecting one of the candidates. The option “change ejection destination” is set by, for example, left-clicking the mouse on a checkbox 713 to display candidates for the changed ejection destination (automatic selection, ejection destination 1, ejection destination 2, and so forth) and selecting one of the candidates.

By displaying the UI image 71 in this manner, the operator is able to check the specification (operation) of an option in the DFE 40a. Specifically, the operator is able to check that, although the option name is “sort” on the option setting screen 61, the option name is “sort (by part)” on the UI screen of the DFE 40a, and the processing details of the option “sort (by part)” are such that, in the case of printing multiple copies of a file containing multiple pages, printing will be done in units of copies. In the exemplary embodiment, the UI image 71 is used as an example of an image of a screen for setting a function in a print control apparatus.

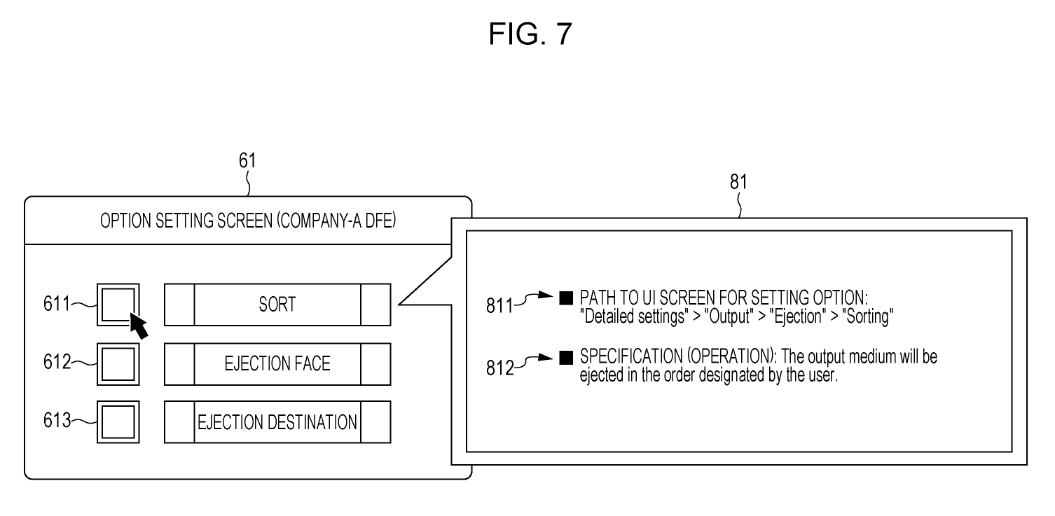

FIG. 7 is a diagram illustrating a state in which the workflow server 10 displays text information 81 on the option setting screen 61. For example, when the UI screen of the DFE 40a is changed from that at the time the UI image 71 is saved, there is no meaning in displaying the UI image 71. When company A is different from a company that has manufactured an application in the workflow server 10, the UI image 71 may not be obtained in some cases. Therefore, in the exemplary embodiment, the DFE 40a not only transmits the UI image 71, but also transmits, as text information 81, path information 811 indicating a screen transition to a UI screen for setting an option, and a description 812 of the specification (operation) of the option. In the exemplary embodiment, the path information 811 is used as an example of text describing a screen transition to a screen for setting a function in a print control apparatus, and the description 812 is used an example of text describing the description of the specification of a function in a print control apparatus.

Instead of transmitting the operation information itself, each DFE 40 may transmit information (such as a Uniform Resource Locator (URL)) on the source of the operation information to the workflow server 10. Alternatively, each DFE 40 may transmit information (such as a URL) on the source of the UI image 71, and may transit the text information 81 itself.

Next, a schematic operation in the case of setting an option in each DFE 40 from the workflow server 10 will be described.

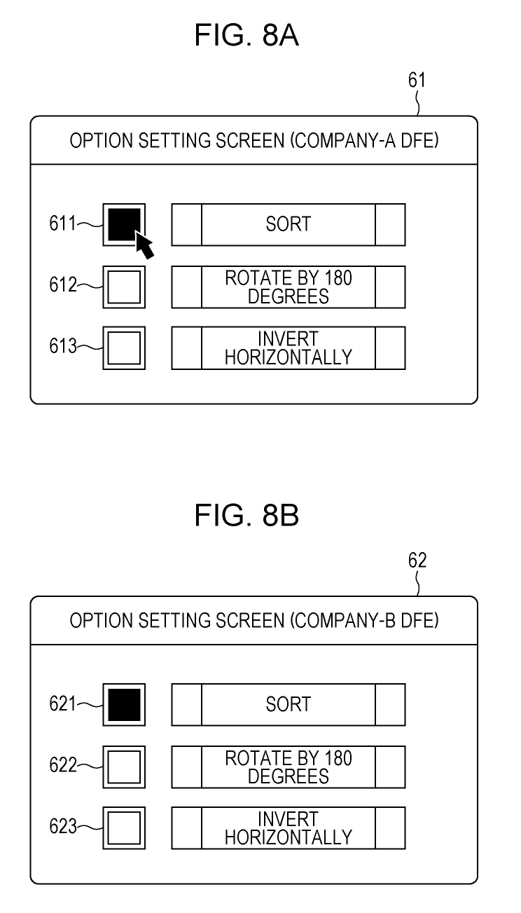

FIG. 8A is a diagram illustrating a state in which the option “sort” is set on the company-A DFE option setting screen 61 displayed by the workflow server 10. This option is set by, for example, left-clicking the mouse on the checkbox 611 to check the checkbox 611. The fact that the option “sort” is set on the option setting screen 61 is indicated by the fact that the checkbox 611 is checked in FIG. 8A.

After that, it is assumed that the operator changes the transmission destination of print instruction information from the DFE 40a to the DFE 40b. For example, although the operator wants to rotate an image by 90 degrees and print the rotated image, it is clear for the operator from the option setting screen 61 that only the option “rotate by 180 degrees” is settable in the DFE 40a. Thus, the operator tries changing the transmission destination of print instruction information to the DFE 40b and sees whether the option “rotate by 90 degrees” is settable in the DFE 40b. In such a case, the transmission destination may be changed.

In this case, it is conceivable to take over (maintain) the settings of an already-set option in order to avoid the burden of re-setting an already-set option.

FIG. 8B is a diagram illustrating the state of a company-B DFE option setting screen 62 displayed by the workflow server 10 in this case. The fact that the option “sort” is set also on the option setting screen 62 is indicated by the fact that a checkbox 621 is checked in FIG. 8B.

Alternatively, because the already-set option will not perform the intended operation in the DFE 40b, the operator may want to display and check the operation information again. Therefore, when the operator changes the transmission destination of print instruction information, the settings of an already-set option may be canceled. Furthermore, in such a case, whether to take over or cancel the settings of an option may be selected by the operator using, for example a pop-up.

### Functional Configuration of Workflow Server and DFE

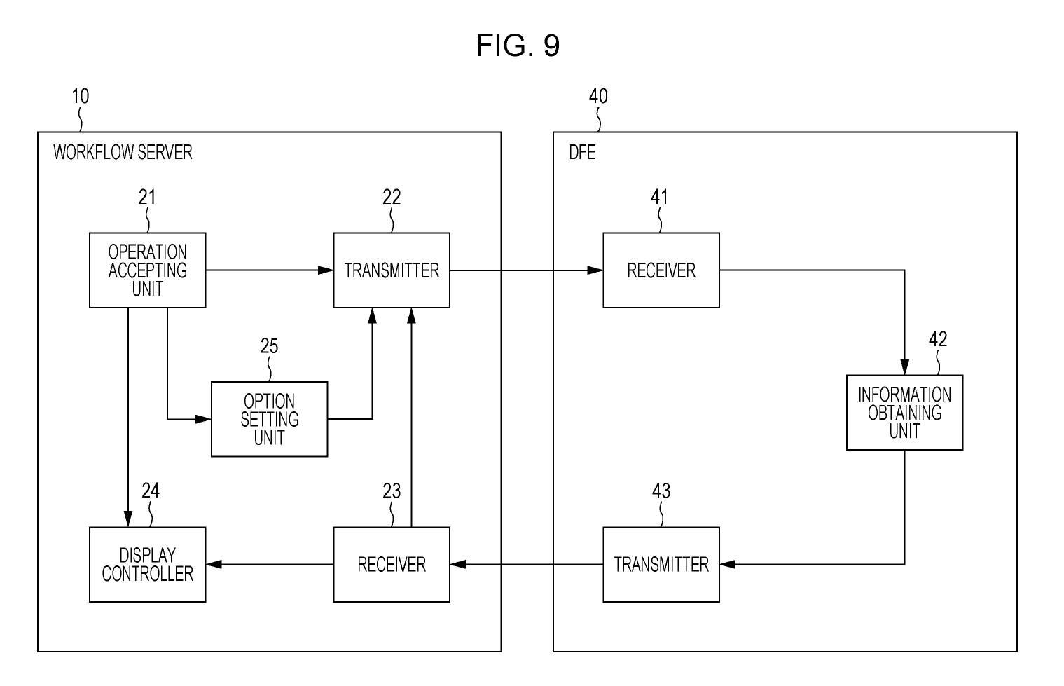

FIG. 9 is a block diagram illustrating an exemplary functional configuration of the workflow server 10 and DFE 40 according to the exemplary embodiment. Although the DFEs 40 are the DFEs 40a, 40b, and 40c in FIG. 1, the DFE 40 in FIG. 9 is the DFE 40a.

As illustrated in FIG. 9, the workflow server 10 includes an operation accepting unit 21, a transmitter 22, a receiver 23, a display controller 24, and an option setting unit 25.

The operation accepting unit 21 accepts an operation of selecting a DFE 40 on the DFE list screen 60, an operation of selecting an option on the option setting screen 61, and an operation of setting an option on the option setting screen 61. In the exemplary embodiment, the operation accepting unit 21 is provided as an example of an accepting unit that accepts an operation of designating a function, and an example of an accepting unit that accepts an operation of setting a function.

When the operation accepting unit 21 accepts an operation of selecting an option, the transmitter 22 transmits a JMF file containing selection information indicating the selected option to the DFE 40. In addition, the transmitter 22 transmits print instruction information where an option is set by the later-described option setting unit 25 to the DFE 40. In the exemplary embodiment, the selection information is used as an example of designation information for designating a function, and the transmitter 22 is provided as an example of a transmitter or a first transmitter that transmits the designation information.

The receiver 23 receives, from the DFE 40, a JMF file containing operation information indicating the operation of the selected option or location information indicating the location of the operation information. In the exemplary embodiment, the receiver 23 is provided as an example of a receiver that receives retention information.

The display controller 24 applies control to display, on a display or the like, the DFE list screen 60, the option setting screen 61, and the operation information contained in the JMF file received by the receiver 23 or the operation information obtained from the location indicated by the location information. In the exemplary embodiment, the display controller 24 is provided as an example of a display that displays retention information.

When the operation accepting unit 21 accepts an operation of setting an option, the option setting unit 25 sets the option in print instruction information and transfers the print instruction information to the transmitter 22. In the exemplary embodiment, the option setting unit 25 is provided as an example of a setting unit that sets, in a print instruction, information indicating that a function is to be used.

The DFE 40 includes a receiver 41, an information obtaining unit 42, and a transmitter 43.

The receiver 41 receives a JMF file containing selection information, and print instruction information where an option is set, from the workflow server 10. In the exemplary embodiment, the receiver 41 is provided as an example of a receiver that receives designation information.

The information obtaining unit 42 obtains operation information indicating the operation of an option indicated by selection information contained in a JMF file received by the receiver 41, or location information indicating the location of the operation information.

The transmitter 43 transmits a JMF file containing the operation information obtained by the information obtaining unit 42 or the location information indicating the location of the operation information to the workflow server 10. In the exemplary embodiment, the transmitter 43 is provided as an example of a transmitter that transmits at least one of information indicating the specification of a function and information on the source of that information, and an example of a second transmitter that transmits retention information.

### Operation of Workflow Server and DFE

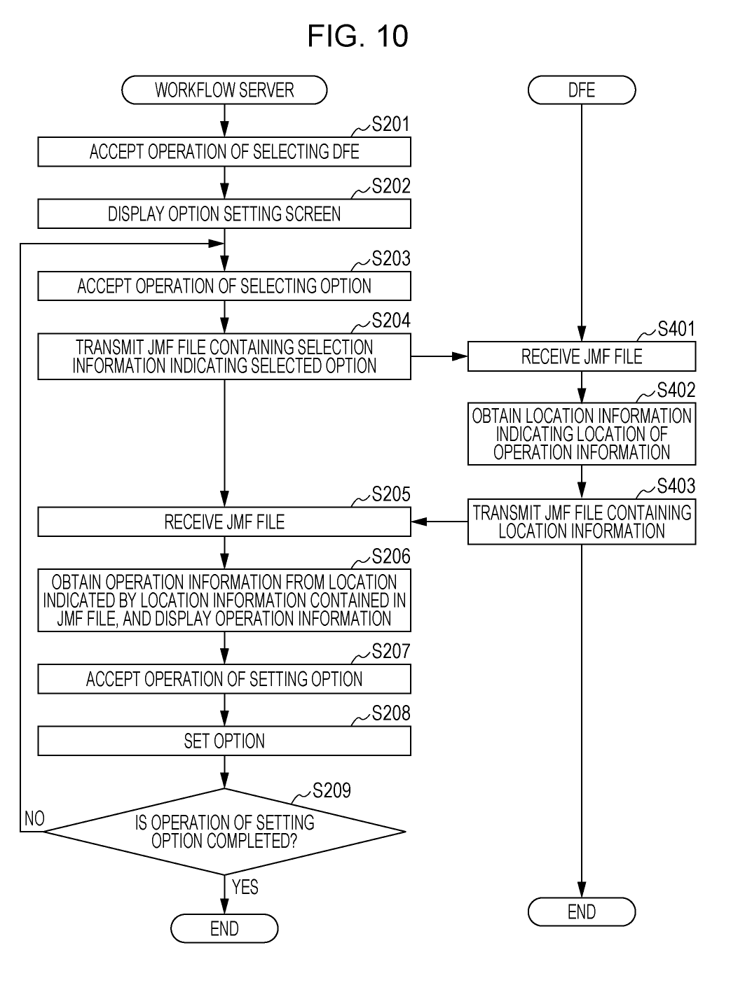

FIG. 10 is a sequence diagram illustrating an exemplary operation of the workflow server 10 and DFE 40 according to the exemplary embodiment of the present invention. Prior to this operation, it is assumed that, in the workflow server 10, the operation accepting unit 21 accepts a request for displaying the DFE list screen 60, and, when there is any connected DFE 40, the display controller 24 displays the DFE list screen 60. It is assumed that the operation starts in this state. Hereinafter, the DFE 40a is assumed as the DFE 40. Furthermore, the description assumes that the DFE 40 transmits to the workflow server 10 location information indicating the location of operation information.

As illustrated in FIG. 10, in the workflow server 10, at first, the operation accepting unit 21 accepts an operation of selecting a DFE 40 on the DFE list screen 60 (step S201). In response to this, the display controller 24 displays the option setting screen 61 for the selected DFE 40 on the display or the like (step S202).

Next, the operation accepting unit 21 accepts an operation of selecting an option on the option setting screen 61 (step S203). In response to this, the transmitter 22 transmits a JMF file containing selection information indicating the selected option to the DFE 40 (step S204). Specifically, the transmitter 22 transmits to the DFE 40 a JMF file containing information indicating the storage location of a JDF file describing a JDF definition indicating the selected option.

Accordingly, in the DFE 40, the receiver 41 receives the JMF file transmitted by the transmitter 22 (step S401). The information obtaining unit 42 obtains, for the option indicated by the selection information contained in the JMF file received by the receiver 41, location information indicating the location of the operation information (step S402). Specifically, the information obtaining unit 42 obtains a JDF definition described in a JDF file at the storage location indicated by the information contained in the JMF file. The information obtaining unit 42 identifies an option in the DFE 40 by referring to the corresponding relationship between this JDF definition and an option name in the DFE 40, and obtains location information indicating the location of operation information indicating the operation of the option. After that, the transmitter 43 transmits a JMF file containing the location information obtained by the information obtaining unit 42 (step S403).

Accordingly, in the workflow server 10, the receiver 23 receives the JMF file transmitted by the transmitter 43 (step S205). The display controller 24 applies control to obtain operation information from the location indicated by the location information contained in the JMF file received by the receiver 23, and to display the operation information on the display or the like (step S206).

Next, in the workflow server 10, the operation accepting unit 21 accepts an operation of setting the option on the option setting screen 61 (step S207). In response to this, the option setting unit 25 sets the option in print instruction information (step S208). After that, the operation accepting unit 21 determines whether the operation of setting the option is completed or not (step S209), and, if the operation accepting unit 21 determines that the operation of setting the option is not completed, the process returns to step S203; and, if the operation accepting unit 21 determines that the operation of setting the option is completed, the process ends.

Although not illustrated in the flowchart, print instruction information in which the option is set by the option setting unit 25 is transferred to the transmitter 22, and the transmitter 22 transmits the print instruction information to the DFE 40.

### Program

Processing performed by the workflow server 10 and DFE 40 according to the exemplary embodiment is prepared as a program such as application software.

That is, a first program for realizing the exemplary embodiment is regarded as a program causing a computer to execute a process including: transmitting designation information for designating a function used in printing to a print control apparatus that controls printing; in response to transmission of retention information retained by the print control apparatus regarding a function on receipt of the transmitted designation information, receiving the retention information; and displaying the received retention information.

In addition, a second program for realizing the exemplary embodiment is regarded as a program causing a computer to execute a process including: receiving designation information for designating a function used in printing from a print instruction control apparatus that controls a printing instruction; and, on receipt of the designation information, transmitting at least one of information indicating a specification of a function designated by the designation information and information on the source of that information.

Needless to say, the program for realizing the exemplary embodiment may be provided by a communication unit or by being stored in a recording medium such as compact-disc read-only memory (CD-ROM) or the like.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print instruction control apparatus comprising:
a transmitter that transmits, to a print control apparatus that controls printing, designation information for designating a function used in printing;
a receiver that receives, in response to transmission of retention information retained by the print control apparatus regarding the function on receipt of the designation information transmitted by the transmitter, the retention information; and
a display that displays the retention information received by the receiver.

2. The print instruction control apparatus according to claim 1, further comprising:
an accepting unit that accepts an operation of designating the function on a screen of the print instruction control apparatus for designating the function,
wherein the transmitter transmits the designation information upon acceptance of the operation by the accepting unit.

3. The print instruction control apparatus according to claim 2, wherein:
the screen is common to a screen of the print instruction control apparatus for setting the function, and
the operation is different from an operation of setting the function.

4. The print instruction control apparatus according to claim 1, wherein the retention information is information retained regarding the function independently by a plurality of print control apparatuses including the print control apparatus.

5. The print instruction control apparatus according to claim 4, wherein the plurality of print control apparatuses are print control apparatuses of an identical manufacturer or of an identical model.

6. The print instruction control apparatus according to claim 1, wherein the retention information is information different from information retained regarding the function by a second print control apparatus other than the print control apparatus.

7. The print instruction control apparatus according to claim 6, wherein the second print control apparatus is a print control apparatus of a different manufacturer or of a different model.

8. The print instruction control apparatus according to claim 1, wherein the retention information is information indicating whether the print control apparatus has the function.

9. The print instruction control apparatus according to claim 1, wherein the retention information is at least one of specification information indicating a specification of the function in the print control apparatus, and information on a source of the specification information.

10. The print instruction control apparatus according to claim 9, wherein the specification information is an image of a screen for setting the function in the print control apparatus.

11. The print instruction control apparatus according to claim 9, wherein the specification information is at least one of text describing a screen transition to a screen for setting the function in the print control apparatus, and text describing a description of the specification of the function in the print control apparatus.

12. The print instruction control apparatus according to claim 1, further comprising:
an accepting unit that accepts an operation of setting the function on a screen of the print instruction control apparatus for setting the function; and
a setting unit that sets, in a print instruction, information indicating that the function is to be used, upon acceptance of the operation by the accepting unit.

13. The print instruction control apparatus according to claim 12, wherein, in response to a change of the print control apparatus in a state where the information indicating that the function is to be used is set in the print instruction, the setting unit maintains the state where the information is set.

14. The print instruction control apparatus according to claim 12, wherein, in response to a change of the print control apparatus in a state where the information indicating that the function is to be used is set in the print instruction, the setting unit cancels the state where the information is set.

15. The print instruction control apparatus according to claim 12, wherein:
the screen is common to a screen of the print instruction control apparatus for designating the function, and
the operation is different from an operation of designating the function.

16. A print control system comprising:
a print instruction controller that controls a print instruction; and
a print controller that controls printing in response to the print instruction, wherein:
the print instruction controller includes:
a first transmitter that transmits designation information for designating a function used in printing to the print controller,
the print controller includes:
a second transmitter that transmits, on receipt of the designation information transmitted by the first transmitter, retention information retained by the print controller regarding the function to the print instruction controller, and
the print instruction controller includes:
a receiver that receives the retention information transmitted by the second transmitter; and
a display that displays the retention information received by the receiver.

17. A non-transitory computer readable medium storing a program causing a computer to execute a process, the process comprising:
transmitting, to a print control apparatus that controls printing, designation information for designating a function used in printing;
in response to transmission of retention information retained by the print control apparatus regarding the function on receipt of the transmitted designation information, receiving the retention information; and
displaying the received retention information.
